(19) United States
(12) Patent Application Publication
(10) Pub. No.: US 2006/0119915 A1
(43) Pub. Date: Jun. 8, 2006

(54) Display panel and display device

(75) Inventors: Takuro Sugiura, Fukushima-ken (JP); Katsuhiko Oshita, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/294,027

(22) Filed: Dec. 5, 2005

(30) Foreign Application Priority Data
Dec. 7, 2004 (JP) 2004-353578

(51) Int. Cl. G02B 5/32

(52) U.S. Cl. 359/15

(57) ABSTRACT

Ultraviolet light, which has propagated through an optical waveguide, propagates in a direction changed by prisms and is emitted from a light-emitting surface to a liquid crystal display panel. The UV incident on the LCD panel is converted into visible light by color filter layers, that is, the visible light conversion layers. A fluorescent material contained in the color filter layers emits visible fluorescent light when UV is irradiated. The visible light is reflected by a reflective layer, is emitted from the LCD display panel, passes through the optical waveguide of a front light and a cover member, and is then viewed by a viewer. A part of the UV is reflected by the light-emitting surface of the optical waveguide or a surface of the LCD.

### BACKGROUND OF THE INVENTION

1. Field of the Invention

The present invention relates to a display panel and a display device, and more particularly, to a display panel and a display device that can improve contrast.

2. Description of the Related Art

Generally, as an illuminating unit of a display device such as a liquid crystal display device, a surface emitting device illuminating a display panel, for example, a front light has been known. FIG. 8 is a diagram showing a structure of a liquid crystal display device having a front light according to the related art. The liquid crystal display device shown in FIG. 8 mainly has a liquid crystal display panel 1 and a front light 2 disposed on the liquid crystal display panel.

The front light 2 mainly has a light source 2a and an optical waveguide 2b emitting light from the light source 2a onto the display panel 1. The optical waveguide 2b has a plate shape, a pair of main surfaces opposite to each other, and a pair of end surfaces opposite to each other. On one main surface (the main surface closer to a viewer), a plurality of prisms 2c are formed. Further, as the light source 2a, for example, a white LED or the like is used.

The liquid crystal display panel 1 mainly has a pair of glass substrates la disposed at a predetermined gap by a sealant 1b, a liquid crystal layer 1c interposed between the glass substrates 1a, a reflective layer 1e formed at the inside of one glass substrate 1a, and a liquid crystal control layer 1d formed on the other glass substrate 1a and the reflective layer 1e.

In the liquid crystal display device, light from the light source 2a of the front light 2 is incident on the end surface of the optical waveguide 2b, and propagates the inside of the optical waveguide 2b. Then, the light is reflected by the prisms 2c in the optical waveguide 2b, propagates the liquid crystal display panel 1, is reflected on the liquid crystal display panel 1, passes through the optical waveguide 2b, and is directed to a viewer 3, as shown by the arrow X in FIG. 8.

However, in the liquid crystal display device, when light is emitted from the optical waveguide 2b, the light is reflected by a light-emitting surface 2d of the optical waveguide 2b and the reflected light (the arrow Y) is directed to the viewer 3. Further, the light emitted from the optical waveguide 2b is reflected on a surface of the glass substrate 1a of the liquid crystal display panel 1 and the reflected light (the arrow Z) is directed to the viewer 3. In this way, when the reflected light (the arrows Y and Z) is viewed by the viewer 3, the display of the liquid crystal panel 1 becomes whitish. As a result, the contrast of the display becomes lowered.

### SUMMARY OF THE INVENTION

The present invention has been finalized in view of the drawbacks, and it is an object of the present invention to provide a display panel and a display device that have high contrast in display.

A display panel according to a first aspect of the invention is provided which includes a display panel main body, and a visible light conversion layer that is provided in the display panel main body and converts ultraviolet (hereinafter, referred to as UV) light from a light source into visible light. Further, a display device according to a second aspect of the invention is provided which an optical waveguide that has a pair of main surfaces opposite to each other, an end surface on which light is incident from a light source, and a plurality of prisms provided in one of the pair of main surfaces, the light source that is disposed in the vicinity of the end surface of the optical waveguide and emits UV light; and the display panel that is disposed opposite to one or the other main surface of the optical waveguide.

In this structure, ultraviolet light that has reached the visible light conversion layer of the display panel is viewed by a viewer as visible light. Meanwhile, since light reflected by a light-emitting surface of the optical waveguide or a surface of the display panel does not pass through the visible light conversion layer, the reflected light is ultraviolet light out of the visible region. Therefore, even though the reflected light is directed to the viewer, the viewer cannot view the reflected light. As a result, only the display is viewed by the viewer without the negative effect of the reflected light in display and the contrast of display is thus improved.

Preferably, the light source emits light having a wavelength within a range of 315 to 500 nm. Further, it is preferable that the display panel be reflective or semi-transmissive liquid crystal display panel. In this case, preferably, at least one of a color filter layer, a planarizing layer, and a reflective layer functions as the visible light conversion layer. Furthermore, in this case, it is preferable that the visible light conversion layer contain a fluorescent material.

Furthermore, preferably, the display panel is a panel for an electronic paper. In this case, it is preferable that the visible light conversion layer contain particles reflecting light. In addition, in this case, it is preferable that the particles contain a fluorescent material.

Preferably, the display device further includes an ultraviolet light cut layer that is disposed on the main surface that opposes to the main surface of the optical waveguide facing the display panel.

According to a structure, even if a light source emitting ultraviolet light is used as a light source, it is possible to reduce the effect of ultraviolet light on a viewer.

### BRIEF DESCRIPTION OF THE DRAWINGS

FIG. 1A is a diagram schematically showing a structure of a liquid crystal display device according to a first embodiment of the invention in a case of white display;

FIG. 1B is a diagram schematically showing a structure of the liquid crystal display device according to the first embodiment of the invention in a case of black display;

FIG. 2 is a cross-sectional view showing a structure of a liquid crystal display panel of the liquid crystal display device according to the first embodiment of the invention;

FIG. 3 is a diagram showing a structure of a panel for an electronic paper, which is a display panel of a display device according to a second embodiment of the invention;

FIG. 4 is a diagram showing a structure of another panel for an electronic paper, which is the display panel of the display device according to the second embodiment of the invention;

FIG. 5 is a diagram showing a structure of another panel for an electronic paper, which is the display panel of the display device according to the second embodiment of the invention;

FIG. 6 is a diagram showing a structure of another panel for an electronic paper, which is the display panel of the display device according to the second embodiment of the invention;

FIG. 7 is a diagram showing relative visibility curves; and

FIG. 8 is a diagram showing a structure of a display device according to the related art.

### DESCRIPTION OF THE PREFERRED EMBODIMENT

The inventors took notice that, if ultraviolet light can be converted into visible light, an ultraviolet light source can be used for a display device, and thus found that, if a layer for converting ultraviolet light into visible light is provided in a display panel, it is possible to make only display of the display panel viewed by a viewer and to make reflected light at undesired portions not viewed by a viewer. On the basis of this point, the invention has made.

That is, the gist of the invention is to provide a display device having high contrast in display using an ultraviolet light source emitting ultraviolet light by providing a display panel with a visible light conversion layer that converts ultraviolet light into visible light.

Hereinafter, preferred embodiments of the invention will be described in detail with reference to the accompanying drawings.

### First Embodiment

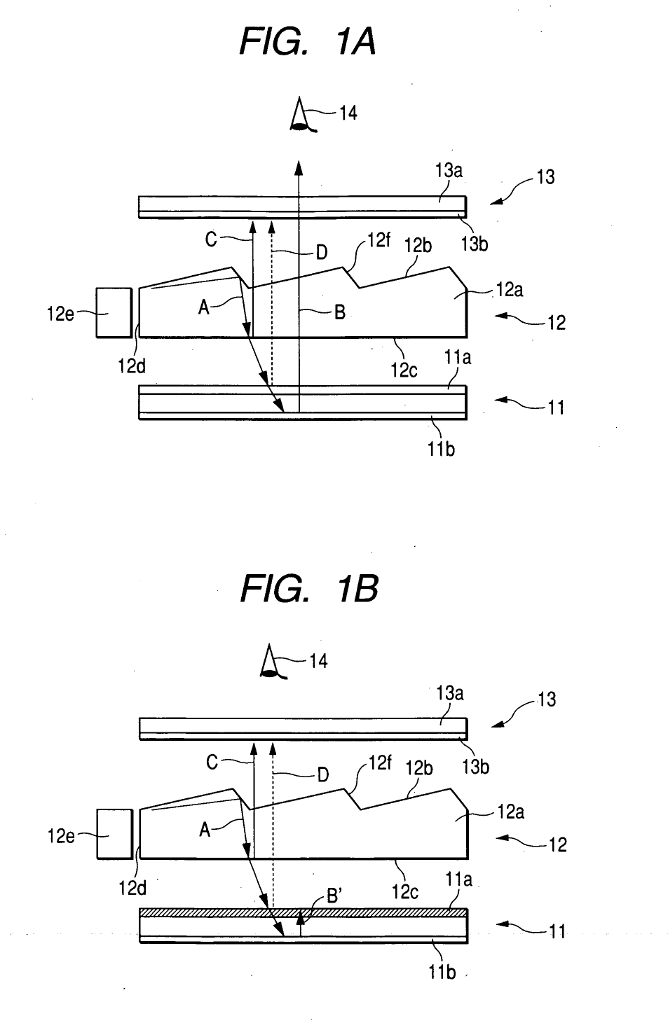

In a first embodiment, a case in which a display panel of a display device is a liquid crystal display panel will be described. As the liquid crystal display panel, a reflective or semi-transmissive liquid crystal display panel can be used. FIG. 1 schematically shows a structure of a liquid crystal display device according to the first embodiment of the invention. In particular, FIG. 1A is a diagram illustrating a case of white display and FIG. 1B is a diagram illustrating a case of black display. The liquid crystal display device shown in FIG. 1 includes a liquid crystal display panel 11, a front light 12 serving as a surface emitting device disposed thereon, and a cover member 13 disposed over the front light 12.

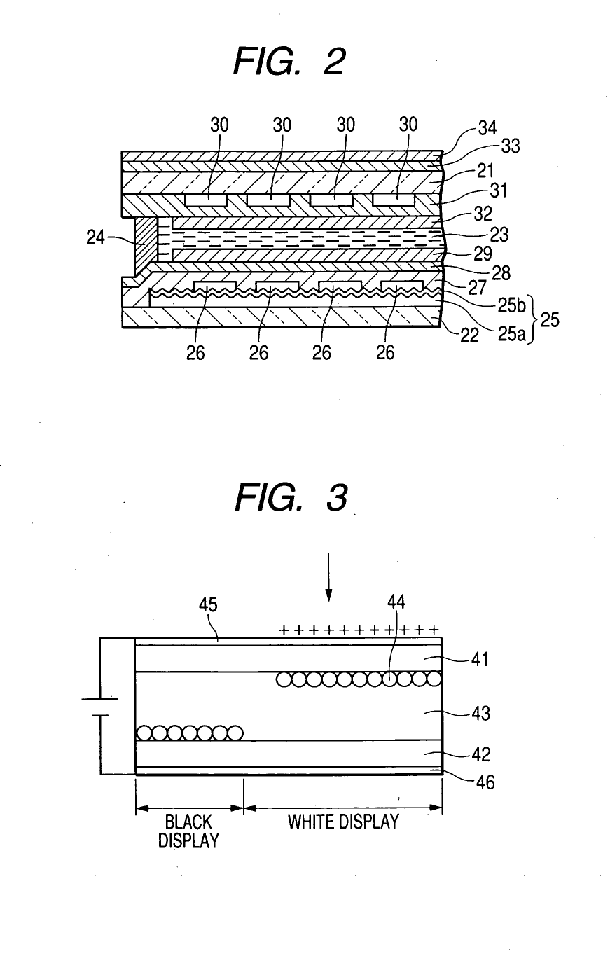

The liquid crystal display panel 11 has at least a liquid crystal layer 11a, which is capable of white display and black display, and a reflective layer 11b reflecting incident light. The liquid crystal layer 11a can perform not only white display and black display but also gray-scale display such as color display. The specific structure of the liquid crystal display panel 11 is shown in FIG. 2.

FIG. 2 is a cross-sectional view showing a structure of the liquid crystal display panel of the liquid crystal display device according to the first embodiment of the invention. The liquid crystal display panel 11 includes a pair of glass substrates 21 and 22, which are disposed at a predetermined gap by a sealant 24, and a liquid crystal layer 23 interposed between the glass substrates 21 and 22.

At the inside (the side of the liquid crystal layer 23) of the lower glass substrate 22, a reflective layer 25 is formed. The reflective layer 25 is composed of an uneven layer 25a, which is made of resin or the like on the glass substrate 22, and a reflective metal film 25b formed on the uneven layer 25a. The reflective layer 25 is not limited to the above-mentioned structure, but may have any other structure capable of reflecting light incident on the liquid crystal display panel 11. On the reflective layer 25, color filter layers 26 are formed. On the reflective layer 25 and the color filter layers 26, a planarizing layer 27 is formed for planarizing the unevenness formed by the reflective layer 25 and the color filters 26. On the planarizing layer 27, a transparent electrode layer 28 is formed of, for example, ITO, for driving liquid crystal molecules in the liquid crystal layer 23. On the transparent electrode layer 28, an alignment layer 29 is formed for controlling the alignment of the liquid crystal molecules in the liquid crystal layer 23.

At the inside (the side of the liquid crystal layer 23) of the upper glass substrate 21, transparent electrode layers 30 are formed of, for example, ITO, for driving the liquid crystal molecules in the liquid crystal layer 23. On the transparent electrode layers 30, a planarizing layer 31 is formed for planarizing the unevenness formed by the upper glass substrate 21 and the transparent electrode layers 30. On the planarizing layer 31, an alignment layer 32 is formed for controlling the alignment of liquid crystal molecules in the liquid crystal layer 23. Further, at the outside of the upper glass substrate 21, a phase difference plate 33 and a polarizer 34 are sequentially disposed.

In the case of assembling the liquid crystal display panel 11 having the above-mentioned structure, first, on one main surface of the glass substrate 21, the transparent electrode layers 30, the polarizing layer 31, and the alignment layer 32 are sequentially formed. Then, on one main surface of the glass substrate 22, the reflective layer 25, the color filter layers 26, the planarizing layer 27, the transparent electrode layer 28, and the alignment layer 29 are sequentially formed. The glass substrates 21 and 22 are disposed so that their alignment layers 32 and 29 are opposite to each other at the predetermined gap and then are fixed to each other by the sealant 24. Next, a liquid crystal material is injected between the glass substrates 21 and 22 and then is sealed. Subsequently, at the outside of the glass substrate 21, the phase difference plate 33 and the polarizer 34 are sequentially disposed. Further, as the method of forming or patterning each layer, it is possible to use a method that is used in the general method of manufacturing a liquid crystal display device.

Each color filter layer 26 functions as a visible light conversion layer, which converts ultraviolet light into visible light. If the visible light conversion function is given to the color filter layer, even though an ultraviolet light source is used as a light source, a viewer 14 can view the display of the liquid crystal display panel. In order to convert ultraviolet light into visible light, the color filter layer 26 contains a fluorescent material. As the fluorescent material, a material can be used which emits light in response to light having a wavelength not more than about 500 nm, preferably, a wavelength within a range of 315 to 500 nm and becomes transparent in a state in which ultraviolet light does not is irradiated thereon. In the case of forming the color filter layer 26 functioning as a visible light conversion layer, a resin constituting the color filter layer 26 is mixed with a predetermined amount of fluorescent material in advance. By forming a layer using the mixed material and patterning the formed layer, the color filter layer 26 is formed. Further, in this embodiment, the case of converting ultraviolet light into visible light by the fluorescent material is being described. However, in this invention, in order to convert ultraviolet light into visible light, it is possible to use a structure other than a structure in which the fluorescent material is mixed.

In present embodiment, the case in which the color filter layer 26 functions as a visible light conversion layer is being described. However, in this invention, any layer located at the inner side than the planarizing layer 27 or 31, or the polarizer 34 such as the reflective layer may function as a visible light conversion layer, or a plurality of layers located at the inner side than the polarizer 34 may serves as a visible light conversion layer. Further, a separated layer may be provided as a visible light conversion layer at the inner side than the polarizer 34. Preferably, the layer functioning as a visible light conversion layer is made of a resin in consideration of the ease of mixture of the fluorescent material. Furthermore, even in the case of forming the planarizing layer, the separated visible light conversion layer, or the like, as described above, first, a resin, which constitutes the planarizing layer, the separated visible light conversion layer, or the like, is mixed with a predetermined amount of fluorescent material in advance. Then, by forming a layer using the mixed material and properly patterning the formed layer, the planarizing layer, the separated visible light conversion layer, or the like is formed.

The front light 12 has a planar shape and includes an optical waveguide 12a and a light source 12e. The optical waveguide 12a has a pair of main surfaces 12b and 12c opposite to each other and a pair of end surfaces 12d opposite to each other, and the light source 12e is disposed in the vicinity of one of the end surfaces 12d of the optical waveguide 12a. On one main surface 12b (the main surface closer to the viewer 14) of the optical waveguide 12a, a plurality of prisms 12f are formed. The liquid crystal display panel 11 is disposed to face one of the pair of main surfaces 12b and 12c. In particular, one main surface (the main surface 12c in FIG. 1) of the optical waveguide 12a faces the liquid crystal display panel 11 and the main surface (the main surface 12b in FIG. 1) of the optical waveguide 12a opposite to the main surface 12c faces the cover member 13.

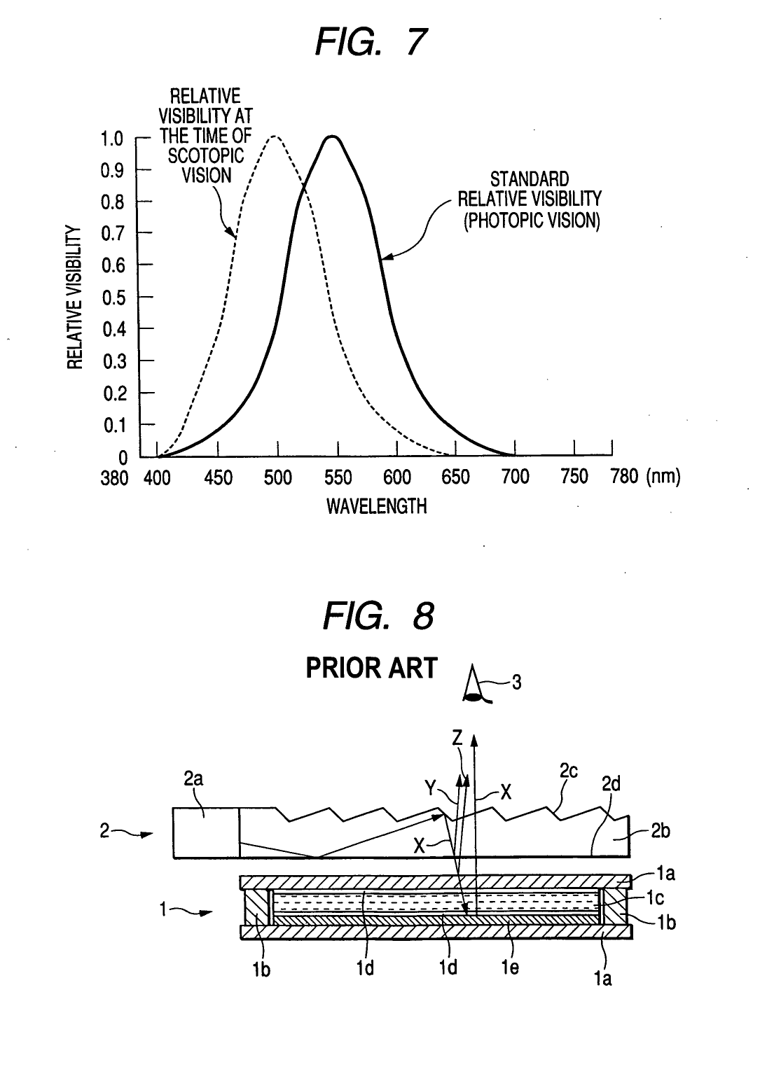

As the light source 12e, a light source for emitting ultraviolet light is used. The wavelength of the light is preferably not more than about 500 nm and, more preferably, about 315 to 500 nm. As shown by a relative visibility curve in FIG. 7, since light having a wavelength exceeding about 500 nm is perceived as bright light by naked eyes, if the light is used for illumination, the contrast of display may be lowered, which is undesirable. Further, since light having a wavelength less than about 315 nm has high energy, the light can deteriorate components of a display device, which is undesirable. Therefore, when a light source, which emits light having a wavelength within a range of 315 to 500 nm, is used, because of the relationship between the light and the visible light conversion layer, it is possible to make the reflected light from a light-emitting surface or the reflected light from the glass substrates of the display panel not viewed by a viewer.

The cover member 13 includes a planar member main body 13a and an ultraviolet light cut layer 13b formed at the inside (the front light side) of the member main body 13a. The ultraviolet light cut layer 13b can be provided if necessary. By providing the ultraviolet light cut layer 13b, it is possible to reduce the effect of ultraviolet light on the viewer 14. As the material of the ultraviolet light cut layer 13b, any material capable of absorbing ultraviolet light can be used.

In the liquid crystal display device having the above-mentioned structure, the viewer 14 can see the display of the liquid crystal display panel 11 through the optical waveguide 12a. In a dark place where external light cannot be obtained, the light source 12e of the front light 12 is made to turn on. First, as shown in FIG. 1A, in the case of white display, ultraviolet light emitted from the light source 12e is introduced into the optical waveguide 12a through the end surface 12d of the optical waveguide 12a and propagates the inside of the optical waveguide 12a. The ultraviolet light having propagated the inside of the optical waveguide 12a propagates in a direction changed by the prisms 12f and is emitted from the light-emitting surface 12c to the liquid crystal display panel 11 (the arrow A).

The ultraviolet light incident on the liquid crystal display panel 11 is converted into visible light by the color filter layers 26, that is, the visible light conversion layers. That is, the fluorescent material contained in the color filter layers 26 emits visible fluorescent light when ultraviolet light is irradiated. The visible light is reflected by the reflective layer 25, is emitted from the liquid crystal display panel 11, passes through the optical waveguide 12a of the front light 12 and the cover member 13, and then is viewed by the viewer 14 (the arrow B). In this case, a part of the ultraviolet light is reflected by the light-emitting surface 12c of the optical waveguide 12a or a surface of the liquid crystal display panel 11. The reflected light (the arrows C and D) does not pass through the visible light conversion layer. That is, the reflected light occurs before being converted into visible light by the visible light conversion layer. For this reason, the reflected light is ultraviolet light out of the visible region. Therefore, even if the reflected light (the arrows C and D) is directed to the viewer 14, the viewer 14 cannot view the reflected light. As a result, the viewer 14 can view only light which has reached the visible light conversion layer of the liquid crystal display panel 11 and thus view only the display of the liquid crystal display panel 11.

Next, even in the case of black display, ultraviolet light emitted from the light source 12e is introduced into the optical waveguide 12a through the end surface 12d of the optical waveguide 12a and propagates the inside of the optical waveguide 12a. The ultraviolet light having propagated the inside of the optical waveguide 12a propagates in a direction changed by the prisms 12f and is emitted from the light-emitting surface 12c to the liquid crystal display panel 11 (the arrow A).

The ultraviolet light incident on the liquid crystal display panel 11 is converted into visible light by the color filter layers 26, that is, the visible light conversion layers. That is, the fluorescent material contained in the color filter layers 26 emits visible fluorescent light when ultraviolet light is irradiated. The visible light is reflected by the reflective layer 25 so as to be directed to the viewer 14. However, since the liquid crystal layer 23 shields the reflected light by a voltage applied between the transparent electrode layers 28 and 30, the reflected light cannot be emitted from the liquid crystal display panel 11 (the arrow B′). Even in this case, a part of the ultraviolet light is reflected on the light-emitting surface 12c of the optical waveguide 12a or a surface of the liquid crystal display panel 11. The reflected light (the arrows C and D) does not pass through the visible light conversion layer as described above. For this reason, the reflected light is ultraviolet light. Therefore, even if the reflected light (the arrows C and D) is directed to the viewer 14, the viewer 14 cannot view the reflected light. As a result, the viewer 14 can view black color. At this time, since the reflected light (the arrows C and D) cannot be viewed, there is no possibility that black display is shown with white display, unlike in the related art.

In this way, in the liquid crystal display device having the above-mentioned structure, in the case of white display, the viewer 14 can view only the ultraviolet light, which has reached the visible light conversion layer of the liquid crystal display panel 11, as display, and in the case of black display, the viewer 14 can view only the black display without the effect of the reflected light (the arrows C and D). As a result, the contrast of display is improved. Further, since the reflected light (the arrows C and D) of the ultraviolet light is absorbed by the ultraviolet light cut layer 13b of the cover member 13, it is possible to reduce the effect of the ultraviolet light on the viewer 14.

### Second Embodiment

In a second embodiment, a case in which a display panel of a display device is a panel for an electronic paper will be described. Since this embodiment is the same as the first embodiment, except for the display panel, the description of the detail structure of the display device will be omitted. FIG. 3 shows a structure of the panel for an electronic paper, which is the display panel of the display device according to the second embodiment of the invention.

The panel for an electronic paper shown in FIG. 3 has a structure in which black insulating liquid 43, which contains white insulating particles 44 reflecting light, is interposed between a pair of glass substrates 41 and 42. When a voltage is applied between the glass substrates 41 and 42, the insulating particles 44 move in the insulating liquid 43 and gather on the surfaces of the glass substrates 41 and 42. Display can be performed by controlling a voltage direction by using the insulating particles 44. For example, as shown in the direction shown by the arrow in FIG. 3, white display can be viewed at the right side and black display can be viewed at the left side. Further, the glass substrate 41 is a glass substrate located at the side of the front light 12, and reference numerals 45 and 46 of FIG. 3 denote electrodes for voltage application.

In this embodiment, a layer formed by the white insulating particles 44 reflecting light, that is, a layer formed by the insulating particles 44 on the glass substrate 41 is a visible light conversion layer, and the insulating particles 44 contain a fluorescent material. As the fluorescent material, the same material as that in the first embodiment can be used.

In the display device having the above-mentioned structure, ultraviolet light emitted from the light source 12e is emitted from the light-emitting surface 12c of the optical waveguide 12a to the display panel shown in FIG. 3 in the same manner as in the first embodiment (the arrow A). In a white display region, the ultraviolet light incident on the display panel is converted into visible light by the visible light conversion layer that is formed by the insulating particles 44. That is, the fluorescent material contained in the insulating particles 44 emits visible fluorescent light when ultraviolet light is irradiated. The visible light is emitted from the display panel, passes through the optical waveguide 12a of the front light 12 and the cover member 13, and is then viewed by the viewer 14 (the arrow B). In the meantime, in a black display region, since the visible light conversion layer, that is, the layer formed by the insulating particles 44 does not exist on the surface of the glass substrate 41, visible fluorescent light is not emitted. Therefore, the viewer 14 can view the black color of the insulating liquid 43.

Even in this case, in the same manner as the first embodiment, the viewer 14 can view only the display of the display panel in the white display region and only the black display in the black display region without the effect of the reflected light (the arrows C and D). Therefore, unlike in the related art, there is no possibility that black display is shown with white display. As a result, the contrast of the display is improved.

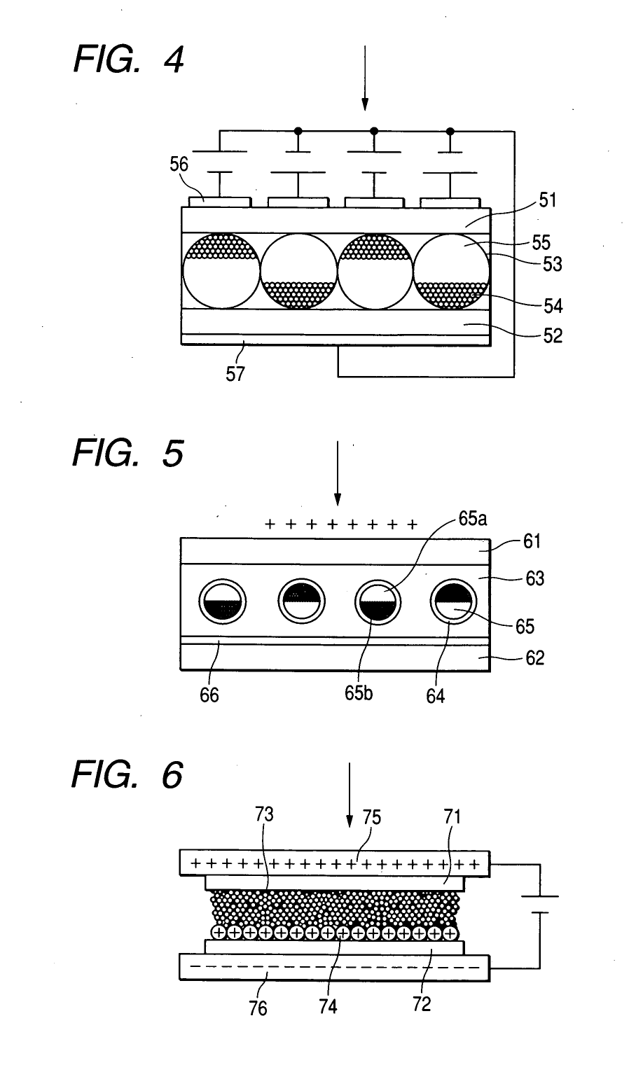

FIG. 4 shows a structure of another panel for an electronic paper, which is the display panel of the display device according to the second embodiment of the invention. The panel for an electronic paper shown in FIG. 4 has a structure in which capsules 53, which contain white migration particles 54 reflecting light and black insulating liquid 55, are disposed between a pair of glass substrates 51 and 52. When a voltage is applied between the glass substrates 51 and 52, the migration particles 54 move in the insulating liquid 55 and gather on the surfaces of the glass substrates 51 and 52. Display can be performed by controlling a voltage direction by using the migration particles 54. For example, as shown in the direction shown by the arrow in FIG. 4, white display can be viewed in the first and third capsules from the left side and black display can be viewed in the second and fourth capsules from the left side. Further, the glass substrate 51 is a glass substrate located at the side of the front light 12, and reference numerals 56 and 57 of FIG. 4 denote electrodes for voltage application.

In this embodiment, the layer formed by the white migration particles 54 reflecting light, that is, the layer formed of the migration particles 54 on the surface of the glass substrate 51 is a visible light conversion layer, and the migration particles 54 contain a fluorescent material. As the fluorescent material, the same material as that in the first embodiment can be used.

In the display device having the above-mentioned structure, ultraviolet light emitted from the light source 12e is emitted from the light-emitting surface 12c of the optical waveguide 12a to the display panel shown in FIG. 4 in the same manner as in the first embodiment (the arrow A). In the capsules in which the migration particles 54 have moved to the glass substrate 51 (the first and third capsules from the left side in FIG. 4), the ultraviolet light incident on the display panel is converted into visible light by the visible light conversion layer formed by the migration particles 54. That is, the fluorescent material contained in the insulating particles 54 emits visible fluorescent light when the ultraviolet light is irradiated. The visible light is emitted from the display panel, passes through the optical waveguide 12a of the front light 12 and the cover member 13, and is viewed by the viewer 14 (the arrow B). Meanwhile, in the capsules in which the migration particles 54 have moved to the glass substrate 52 (the second and fourth capsules from the left side in FIG. 4), since the visible light conversion layer, that is, the layer formed by the migration particles 54 does not exist on the surface of the glass substrate 51, visible fluorescent light is not emitted. Therefore, the viewer 14 can view the black color of the insulating liquid 55.

Even in this case, as in the first embodiment, the viewer 14 can view only the display of the display panel in the capsules (the white display region) in which the migration particles 54 have moved to the glass substrate 51 and only the black display in the capsules (the black display region) in which the migration particles 54 have moved to the glass substrate 51 without the effect of the reflected light (the arrows C and D). Therefore, unlike in the related art, there is no possibility that black display is shown with white display. As a result, the contrast of the display is improved.

FIG. 5 shows a structure of still another panel for an electronic paper, which is the display panel of the display device according to the second embodiment of the invention. The panel for an electronic paper shown in FIG. 5 has a structure in which an insulating solid 63 is disposed between a pair of protective layers 61 and 62, the insulating solid 63 is filled with transparent insulating liquid 64, and rotation display balls are suspended in the insulating liquid 64. In each rotation display ball, one half is white and the other half is black. The white portion 65a of the rotation display ball 65 is made of a white resin and the black portion 65b of the rotation display ball 65 is made of a black resin. Further, the charged state of the white portion of the rotation display ball 65 is different from that of the black portion. The direction of the rotation display ball 65 is controlled by controlling the direction of the electric field in the thickness direction of the display panel. In this way, it is possible to perform the display of the white portion 65a or the black portion 65b of the rotation display ball 65 toward the side of the protective layer 61. For example, as shown in the arrow direction shown by the arrow of FIG. 5, white display can be viewed by the first and third rotation display balls from the left and black display can be viewed by the second and fourth rotation display balls from the left. Furthermore, the protective layer 61 is a protective layer located at the side of the front light 12 and a reference numeral 66 in FIG. 5 denotes a conductive layer for electric field control.

In this embodiment, the white portion 65a of the rotation display ball 65 reflecting light, that is, the portion facing the protective layer 61 is a visible light conversion layer and contains a fluorescent material. As the fluorescent material, the same material as that in the first embodiment can be used.

In the display device having the above-mentioned structure, ultraviolet light emitted from the light source 12e is emitted from the light-emitting surface 12c of the optical waveguide 12a to the display panel shown in FIG. 5 in the same manner as in the first embodiment (the arrow A). In the rotation display balls 65 of which the white portions 65a face the protective layer 61 (the first and third rotation display ball from the left in FIG. 5), the ultraviolet light incident on the display panel is converted into visible light by the white portions 65a. That is, the fluorescent material contained in the white portions 65a emits visible fluorescent light when the ultraviolet light is irradiated. The visible light is viewed by the viewer 14 from the display panel through the optical waveguide 12a of the front light 12 and the cover member 13 (the arrow B). Meanwhile, in the rotation display balls 65 of which the black portions 65b face the protective layer 61 (the second and fourth rotation display balls from the left in FIG. 5), since the visible light conversion layers, that is, the white portions 65a do not face the protective layer 61, visible fluorescent light is not emitted. Therefore, the viewer 14 can view the black color of the black portions 65b.

Even in this case, as in the first embodiment, the viewer 14 can view only the display of the display panel in the rotation display balls 65 of which the white portions 65a face the protective layer 61 (a white display region) and only the black display in the rotation display balls 65 of which the black portions 65b face the protective layer 61 (a black display region) without the effect of the reflected light (the arrows C and D). Therefore, unlike in the related art, there is no possibility that black display is shown with white display. As a result, the contrast of the display is improved.

FIG. 6 shows a structure of still another panel for an electronic paper, which is the display panel of the display device according to the second embodiment of the invention. The panel for an electronic paper shown in FIG. 6 has a structure in which negatively charged white particulates 73 reflecting light, and positively charged black particles 74 are interposed between a pair of glass substrates 71 and 72. When a voltage is applied between the glass substrates 71 and 72, the white particulates 73 move to the plus side and the black particles 74 move to the minus side. Display can be performed by controlling a voltage direction by using the particulates 73 and the particles 74. For example, as shown in the direction shown by the arrow in FIG. 6, the white display can be viewed in the entire surface. Further, the glass substrate 71 is a glass substrate located at the side of the front light 12, and reference numerals 75 and 76 of FIG. 6 denote electrodes for voltage application.

In this embodiment, the layer formed of the white particulates 73 reflecting light, that is, the layer formed of the particulates 73 on a surface of the glass substrate 71 is a visible light conversion layer, and the particulates 73 contains a fluorescent material. As the fluorescent material, the same material as that in the first embodiment can be used.

In the display device having the above-mentioned structure, ultraviolet light emitted from the light source 12e is emitted from the light-emitting surface 12c of the optical waveguide 12a to the display panel shown in FIG. 6 in the same manner as in the first embodiment (the arrow A). In a state in which the particulates 73 have moved to the glass substrate 71, the ultraviolet light incident on the display panel is converted into visible light by the visible light conversion layer formed of the particulates 73. That is, the fluorescent material contained in the particulates 73 emits visible fluorescent light when ultraviolet light is irradiated. The visible light is emitted from the display panel, passes through the optical waveguide 12a of the front light 12 and the cover member 13, and is then viewed by the viewer 14 (the arrow B). Meanwhile, in a state in which the particles 74 have moved to the glass substrate 71, since the visible light conversion layer, that is, the layer formed by the particulates 73 does not exist on the surface of the glass substrate 71, visible fluorescent light is not emitted. Therefore, the viewer 14 can view the black color of the particles 74.

Even in this case, as in the first embodiment, the viewer 14 can view only the display of the display panel in the state in which the particulates 73 have moved to the glass substrate 71 (the white display region) and only the black display in the state in which the particles 74 have moved to the glass substrate 71 (the black display region) without the effect of the reflected light (the arrows C and D). Therefore, unlike in the related art, there is no possibility that black display is shown with white display. As a result, the contrast of the display is improved.

The invention is not limited to the first and second embodiments but various modifications can be made. For example, optical components such as the optical waveguide, the polarizer, and the phase difference plate are not limited to plate-shaped components in the first and second embodiments but can be film-shaped or sheet-shaped components. Further, structures of the display devices according to the first and second embodiments are not limited thereto but various modifications can be made. Furthermore, the invention can be properly modified without departing from the spirit and scope thereof.

According to the display device, since the visible light conversion layer for converting UV light into visible light is provided on the display panel and the light source for emitting the UV light is used as the light source, the contrast can be improved in display.

1. A display panel comprising:
a display panel main body, and
a visible light conversion layer that is provided in the display panel main body and converts ultraviolet light from a light source into visible light.

2. A display device comprising:
an optical waveguide that has a pair of main surfaces opposite to each other, an end surface on which light is incident from a light source, and a plurality of prisms provided in one of the pair of main surfaces,
the light source that is disposed in the vicinity of the end surface of the optical waveguide and emits ultraviolet light,
a display panel that has a display panel main body, and a visible light conversion layer that is provided in the display panel main body and converts ultraviolet light from a light source into visible light; and
wherein the display panel is disposed opposite to one of the main surfaces of the optical waveguide.

3. The display device according to claim 2,
wherein the light source emits light having a wavelength within a range of 315 to 500 nm.

4. The display device according to claim 2,
wherein the display panel is a reflective or semi-transmissive liquid crystal display panel.

5. The display device according to claim 2,
wherein at least one of a color filter layer, a planarizing layer, and a reflective layer functions as the visible light conversion layer.

6. The display device according to claim 2,
wherein the visible light conversion layer contains a fluorescent material.

7. The display device according to claim 2,
wherein the display panel is a panel for an electronic paper.

8. The display device according to claim 7,
wherein the visible light conversion layer contains particles reflecting light.

9. The display device according to claim 8,
wherein the particles contain a fluorescent material.

10. The display device according to claim 2, further comprising:
an ultraviolet light cut layer that is disposed on the main surface that is opposite to the main surface of the optical waveguide facing the display panel.
